(19) United States
(12) Patent Application Publication
(10) Pub. No.: US 2003/0027609 A1
(43) Pub. Date: Feb. 6, 2003

(54) Cellular phone

(76) Inventor: Tomohiro Endo, Osaka (JP)

Correspondence Address: Richard M. Goldberg, Suite 419, 25 East Salem Street, Hackensack, NJ, 07601, US

(21) Appl. No.: 10/118,184

(22) Filed: Apr. 8, 2002

(30) Foreign Application Priority Data
Aug. 2, 2001 (JP) 234655/2001

(51) Int. Cl. H04B 1/38

(52) U.S. Cl. 455/575; 455/90

(57) ABSTRACT

There is provided a constitution of cellular phone which can serve also as a pocket mirror. The cellular phone has a mirror surface formed over a surface region of its outer case excluding the surface region where pushbuttons are provided, and thus the cellular phone can be utilized also as a pocket mirror.

### BACKGROUND OF THE INVENTION

The present invention relates generally to a constitution of cellular phone, more specifically to a constitution that allows an existing cellular phone to serve also as a toilet mirror.

Cellular phones are now downsized, and their functions are diversified more and more.

Meanwhile, a pocket mirror, which is used as a portable toilet mirror, is an article for grooming to be commonly carried with when one goes out.

However, it is cumbersome to carry a cellular phone and a pocket mirror as separate items with him or her.

Nevertheless, there has so far been proposed no idea of allowing a cellular phone to serve also as a pocket mirror.

It is an objective of the present invention to provide a constitution of cellular phone, which allows an existing cellular phone to serve also as a mirror.

### SUMMARY OF THE INVENTION

In order to solve the problem described above, the present invention provides a constitution of cellular phone having a mirror surface on its outer case over a surface region excluding a zone where pushbuttons are provided.

Other aspects and advantages of the invention will become apparent from the following description, taken in conjunction with the accompanying drawings illustrated by way of examples the principles of the invention.

### BRIEF DESCRIPTION OF THE DRAWING

The features of the present invention that are believed to be novel are set forth with particularity in the appended claims. The invention together with the objects and advantages thereof, may best be understood by reference to the following description of the presently preferred embodiments together with the accompanying drawings in which:

FIG. 1 is a perspective view showing a constitution of cellular phone according to a first embodiment of the present invention;

FIG. 2 is a schematic drawing showing a state where metal particles are sputtered onto the outer case to form a mirror surface for explaining a constitution of cellular phone according to a second embodiment of the present invention;

FIGS. 3(a) and 3(b) show one typical example of the present invention; FIG. 3(a), a plan view of the side (front side), which has pushbuttons and a built-in speaker and which is to be brought into contact with one's ear; and FIG., 3(b), a plan view of the side (rear side) provided with a mirror surface; and

FIG. 4 is a plan view showing another typical example of the present invention.

### DETAILED DESCRIPTION OF THE INVENTION

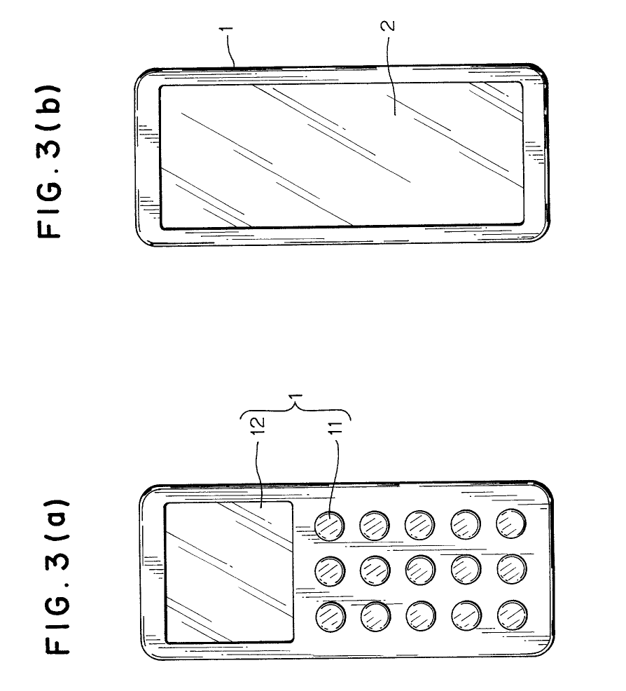

FIGS. 3(a) and 3(b) show a typical example of the cellular phone according to the present invention. The cellular phone 1 has, on one side (front side), a surface region 11 provided with pushbuttons and another surface region 12 which has a built-in speaker and which is to be brought into contact with one's ear, and on the other side (rear side), a surface region having a mirror surface formed thereon.

The above example is characterized in that the overall surface of the cellular phone 1 is effectively utilized by providing a mirror surface 2 on a surface region excluding the zones which can exhibit principal functions of the cellular phone 1.

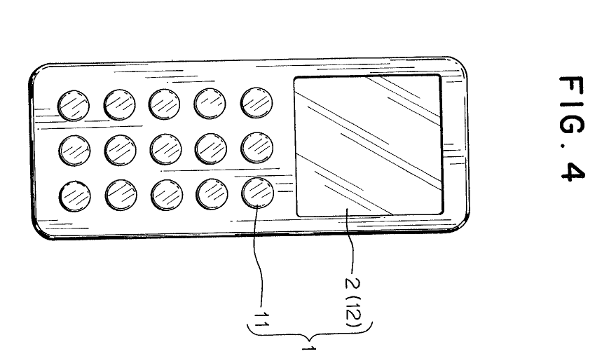

FIG. 4 shows a case where the mirror surface 2 is formed on the same side as the surface region 11 containing the pushbuttons is present and coinciding with the surface region 12 which has a built-in speaker and which is to be brought into contact with one's ear.

Since the mirror surface 2 can be generally formed by a thin film containing a metallic layer, it does not interfere with transmission of voice from the speaker.

The example illustrated in FIG. 4 is characterized in that, while one is operating the pushbuttons, one can observe his or her appearance with the mirror surface 2 locating above the pushbuttons.

The cellular phone 1 generally has a flat surface, so that it is naturally possible to form by metal particles 21 or the like the mirror surface 2 capable of realizing specular reflection.

While formation of the mirror surface 2 is generally realized by forming a thin film with metal particles 21 having high reflectance, metal particles such as of silver and mercury can suitably be used.

The most convenient method for forming the mirror surface 2 is to apply a coating on a surface of a base film by means of metal plating and the like, and bonding the front side (coated side) or the rear side of the base film to an appropriate surface region of the outer case.

In the above method, if the base film is bonded at the front side to the outer case, it is significant in that the mirror surface 2 can be covered by the base film over the case where the base film is bonded at the rear side. However, it can happen that the efficiency of specular reflection is lowered depending on the transparency of the base film.

As described above, the present invention enables a user of the cellular phone 1 to use it occasionally as a pocket mirror, providing uses of the cellular phone 1 not only for communication but also as a casual portable grooming tool.

The present invention will be described below by way of embodiments.

### Embodiment 1

Cellular phones 1 of fold-up constitution are introduced recently. In such a constitution, a surface region 11 having pushbuttons is formed on one inner surface region which is brought into contact with the other inner surface region when the cellular phone 1 is folded up.

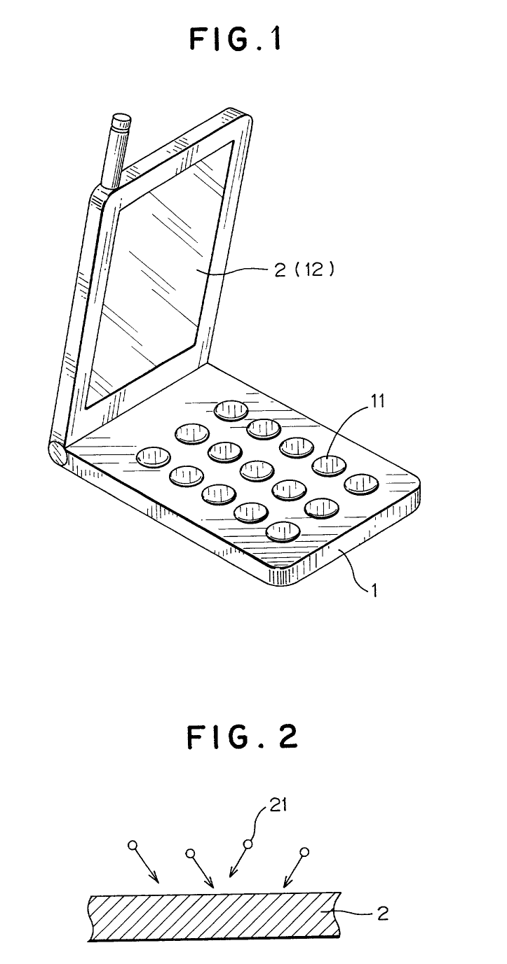

The first embodiment is characterized in that the mirror surface 2 is formed on that inner surface region which is lapped over the other inner surface region 11 provided with the pushbuttons, when the cellular phone 1 is folded up, as shown in FIG. 1.

Incidentally, in the first embodiment, the mirror surface 2 is frequently used also as the surface region 12 to be brought into contact with one's ear like in the case of FIG. 4.

In the constitution of the first embodiment described above, the mirror surface 2 is formed on a surface to be located on the inner side when the cellular phone 1 is folded up, so that the mirror surface can be used like an ordinary pocket mirror is used. In addition, the mirror surface is generally located inside when the cellular phone 1 is folded up, and thus the mirror surface can be prevented from wearing through contact with external matters.

### Embodiment 2

Formation of the mirror surface 2 on the surface region of the outer case is not to be limited to the method described above, i.e., to bond the rear side of a metal-plated base film to a surface region of the outer case.

In the second embodiment, the mirror surface 2 is formed by means of vapor deposition or sputtering to impinge metal particles 21 straight upon the desired surface region of the case to form a substantially flat metal film, as shown in FIG. 2.

In the mirror surface 2 formed according to the method of the second embodiment, the metal particles adhere firmly onto the surface region, preventing or reducing the risk that the mirror surface 2 is damaged by contact with external matters.

In the method of the second embodiment, it is of course possible to apply a transparent plastic cover over the mirror surface 2 so as to prevent wearing of the mirror surface 2 through contact with external matters.

In the present invention having the constitution described above, the cellular phone can be utilized also as a pocket mirror, contributing much to improvement of convenience in our daily lives.

As has been described heretofore, the cellular phone of the present invention is beneficially utilized for diversified applications and is of great worth in spite of its simple idea.

It should be apparent to those skilled in the art that the present invention may be embodied in many other specific forms without departing from the spirit or scope of the invention.

Therefore, the present examples and embodiments are to be considered as illustrative and not restrictive, and the invention is not to be limited to the details given herein, but may be modified within the scope of the appended claims.

What is claimed is:

1. A cellular phone comprising a mirror surface provided on an outer case thereof over a surface region excluding a zone where pushbuttons are provided.

2. The cellular phone according to claim 1, wherein the mirror surface is formed on the same side as the surface region having the pushbuttons is present.

3. The cellular phone according to claim 1, wherein the mirror surface is formed on a side opposite to that where the surface region having the pushbuttons is present.

4. The cellular phone according to claim 1, wherein the outer case is of fold-up type, and the mirror surface is formed on one inner surface region that is lapped over the other inner surface region when the outer case is folded up.

5. The cellular phone according to claim 1, wherein the mirror surface is formed by applying a coating over a base film, and the coated base film is bonded to a surface region of the outer case.

6. The cellular phone according to claim 1, wherein the mirror surface is formed by means of vapor deposition or sputtering of metal particles.
